(19) United States
(12) Patent Application Publication
(10) Pub. No.: US 2024/0388048 A1
(43) Pub. Date: Nov. 21, 2024

(54) A CONNECTOR

(71) Applicant: Micromass UK Limited, Wilmslow (GB)

(72) Inventor: Haydn Murray, Stockport (GB)

(73) Assignee: Micromass UK Limited, Wilmslow (GB)

(21) Appl. No.: 18/691,376

(22) PCT Filed: Jun. 30, 2022
(86) PCT No.: PCT/GB2022/051693

§ 371 Date: Mar. 12, 2024

(30) Foreign Application Priority Data
Sep. 13, 2021 (GB) 2113033.1

(51) Int. Cl. H01R 24/84; H01R 13/41; H01R 13/66; H01R 24/20; H01R 24/28; H01R 101/00

(52) U.S. Cl. CPC H01R 24/84; H01R 13/6683; H01R 24/20; H01R 24/28; H01R 13/41; H01R 2101/00

(57) ABSTRACT

A connector comprising a connector body configured for connection to an identical connector body, the connector body having a male part and a female part, which have profiles that conform, at least partially, to one another.

### TECHNICAL FIELD

The present disclosure relates generally to the field of connectors, and more particularly to connectors for use with thermocouples.

### BACKGROUND

Thermocouples are very small robust devices used for measuring temperature, which work using the Seebeck effect of generating a small temperature dependent voltage at the junction of two dissimilar metals. Adding connections to the thermocouples creates additional junctions that change the generated voltage. To mitigate this, thermocouple specific connectors use the same metals that the thermocouple is made from and thus do not effect the generated voltage.

A problem arises that the commercially available connectors are relatively large (micro IEC connectors with male and female connected together have dimensions of 40 mm×15 mm×8 mm). Screw down spade style connectors are also available but are still large (dimensions of 30 mm×8 mm×4 mm per contact).

Individual spade style connectors have the advantage of separating the positive and negative contacts so they can be positioned independently, which is beneficial, however errors can be made in the assembly as the positive and negative look the same. If they are assembled incorrectly then the generated voltage is changed.

The present invention arose in a bid to provide an improved connector (or contact) suitable for use with thermocouples and addressing some of the shortcomings of the prior art.

### SUMMARY

According to a first aspect, there is provided a connector comprising a connector body configured for connection to an identical connector body, the connector body having a male part and a female part, which have profiles that conform, at least partially, to one another.

The connector preferably, comprises a substantially planar connection face.

The connector body may comprise a first portion and a second portion.

The first portion may comprise the connection face. The connection face may be recessed with respect to the second portion. The recess may be shallower than a thickness of the first portion.

The male and/or female parts may be provided on the connector surface.

The second portion may comprise a recess for receiving a wire to be joined to the connector.

According to a further aspect, there is provided a connector comprising a connector body comprising a first portion and a second portion, wherein the first portion comprises a substantially planar connection face, which is recessed with respect to the second portion.

According to a further aspect, there is provided a connector comprising a connector body comprising a first portion and a second portion, wherein the first portion comprises a substantially planar connection face and the second portion comprises a recess for receiving a wire to be joined to the connector.

Further, preferable, features of any of the above aspects, are as follows:

A step may be defined between the first and second portions. The step may have a smaller depth than a thickness of the second portion.

An opening may be provided that passes through the connection face. The opening preferably extends though the body portion.

A recess may be provided for receiving a wire to be joined to the connector. A sleeve may be provided that covers the recess for receiving the wire. A wire may be attached to the connector body by spot welding.

The connector body is preferably unitarily formed. It may be formed from a solid blank of material. It may be formed by machining.

The male and female parts may lie in different planes to one another. The planes may be parallel to one another. The male and female parts may each be substantially planar.

The male and female parts may extend along axes that are parallel to one another.

There may be one, two or more male/female parts provided. The one or more male parts may comprise lugs, prongs, or otherwise. The one or more female parts may comprise openings, cutouts, or otherwise.

Where there are multiple male members, the opening may be formed between adjacent male parts.

When there is a step, as discussed above, the female part may comprise a cutout formed in the step, such that the step has a profile conforming at least in part to the profile of the male part.

The male and female parts may extend along axes that are substantially perpendicular to the connection face. The male part may project from the connection face. The female part may be formed in the connection face. It may comprise the opening.

The male part may be provided on a periphery of the opening with a profile conforming in part to the profile of the opening. It may comprise inner and outer faces that confirm to the opening. The opening may have an elongate profile. It may be substantially oval.

The connector may comprise a thermocouple connector.

According to a further aspect, there is provided an assembly comprising a pair of the connectors, as defined in any of the aspects/statements above.

The connectors are preferably arranged to be connected to one another with the male and female parts interconnected when the connectors are oriented at 180 degrees to one another.

The connectors are preferably arranged to be connected to one another with the connection faces contacting one another.

The connectors are preferably arranged such that when the connectors are connected to one another, the openings of the connectors are aligned with one another for receiving a fastener there through. The openings preferably combine to define an opening through the assembly having a substantially circular profile.

The connectors are preferably arranged such that when the connectors are connected to one another to form connections, the overall dimensions of the connections are within the following limits: length=30 mm or less, width=10 mm or less, and depth=5 mm or less, or length=25 mm or less, width=5 mm or less, and depth=2.5 mm or less.

According a further aspect, there is provided a set of connectors comprising: a first pair of connectors comprising first and second connectors according to any of the above aspects/statements, which comprise identical connector bodies to one another; and a second pair of connectors comprising third and fourth connectors according to any of the above aspects/statements, which comprise identical connector bodies to one another, wherein the connector bodies of the first and second connectors are different to the connector bodies of the third and fourth connectors.

The first and second connectors may differ from the third and fourth connectors in respect of the shape and/or configuration of the male and female parts, or otherwise.

According to a further aspect, there is provided a thermocouple comprising a connector as defined in any of the aspects/statements above.

These and other aspects and features of the present disclosure will be more readily understood when read in conjunction with the accompanying drawings. Moreover, it must be noted that the various features of any of the above statements may be combined without restriction, as will be readily appreciated by those skilled in the art.

### BRIEF DESCRIPTION OF THE DRAWINGS

FIG. 1 is perspective view of a connector according to a first embodiment;

FIG. 2 is a perspective view showing an assembly comprising two of the connectors according to the first embodiment connected to one another;

FIG. 3 is a perspective view of a connector according to a second embodiment;

FIG. 4 is a perspective view showing an assembly comprising two of the connectors according to the second embodiment connected to one another;

FIG. 5 is a side view of the assembly of FIG. 2;

FIG. 6 is a plan view of the connector of the first embodiment with its sleeving removed; and

FIGS. 7a and 7b show a set of connectors, which comprises a pair of connectors according to the first embodiment and a pair of connectors according to the second embodiment.

### DETAILED DESCRIPTION

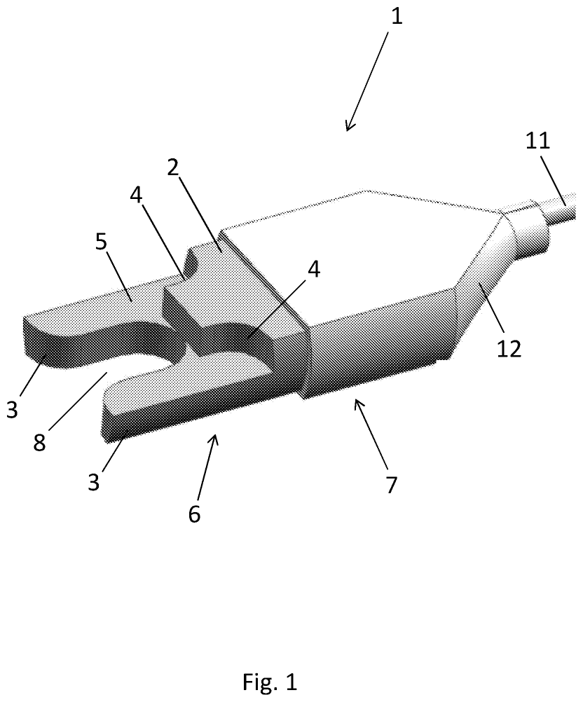

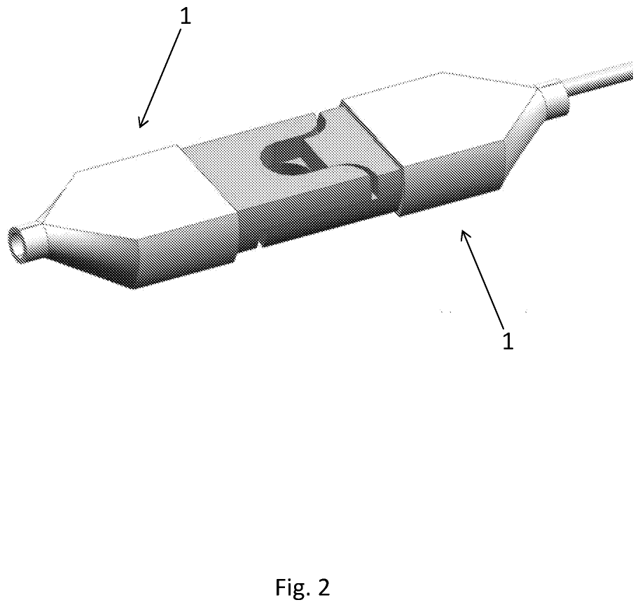

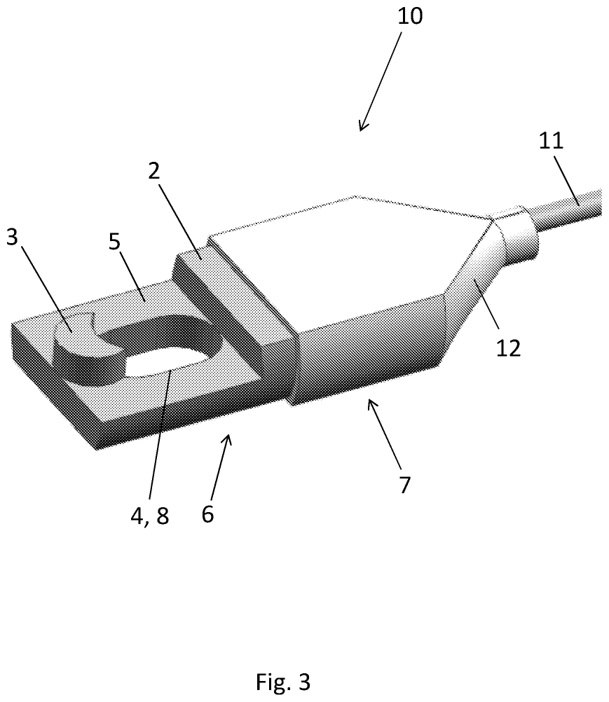

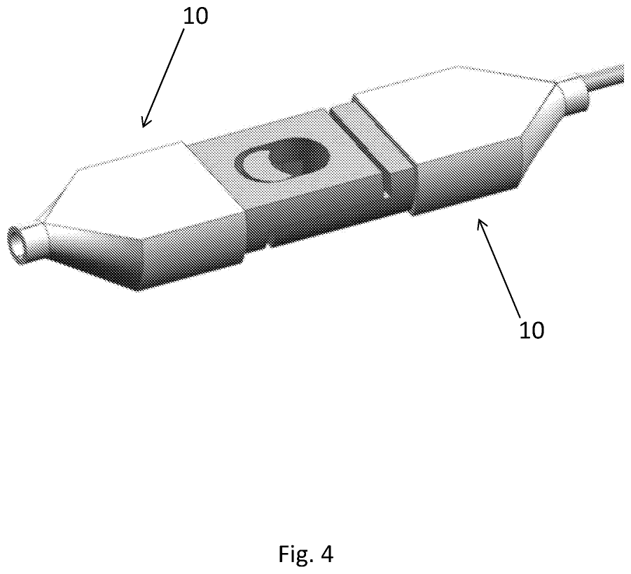

FIG. 1 shows a connector according to a first embodiment whilst FIG. 3 shows a connector according to a second embodiment. The connectors are, preferably, thermocouple connectors. Connector bodies of the first and second embodiments are configured for connection to identical connector bodies to themselves. FIG. 2 shows two connectors according to the first embodiment with identical connector bodies connected to one another to define an assembly (or connection). FIG. 4 shows two connectors according to the second embodiment with identical connector bodies connected to one another to define a second assembly (or connection). The differences between the connectors of the first and second embodiments will be clear from the detailed discussion of these embodiments below.

The connectors of the first embodiment cannot readily be connected to the connectors of the second embodiment owing to different connector body configurations. Two connectors of the first embodiment may, for example, be used for a positive electrical connection whilst two connectors of the second embodiment may be used for a negative electrical connection, or vice versa, wherein owing to the inherent incompatibility between the connector bodies of the first and second embodiments, there is no risk of cross connection. However, since the connector bodies of the first and second embodiments connect to identical connector bodies to themselves, there is no need for separate male and female connectors for each of the positive and negative connections.

It is to be noted that the first and second embodiments are presented as non-limiting, exemplary, arrangements only, wherein further or alternative arrangements will be readily appreciated by those skilled in the art within the scope of the claims. For example, connectors with alternatively formed male and female parts, or otherwise, may be provided.

Considering the connector 1 of FIG. 1, there is provided a connector body 2, which, as discussed, is configured for connection to an identical connector body 2 (as shown in FIG. 2). The connector body 2 has a male part 3 and a female part 4, which have profiles that conform, at least partially, to one another, as clearly seen in FIG. 2. In the present arrangement, there are two male parts 3 provided and two female parts 4. In alternative arrangements, there may be more or less male/female parts provided, as will be readily appreciated by those skilled in the art.

As is preferred, the connector comprises a substantially planar connection face 5, which is defined by the connector body 2. In the present arrangement, the connector body 2 may be considered to comprise a first portion 6 and a second portion 7. It should be appreciated that in alternative arrangements, there need not be two defined portions and alternative arrangements may not be configured as such.

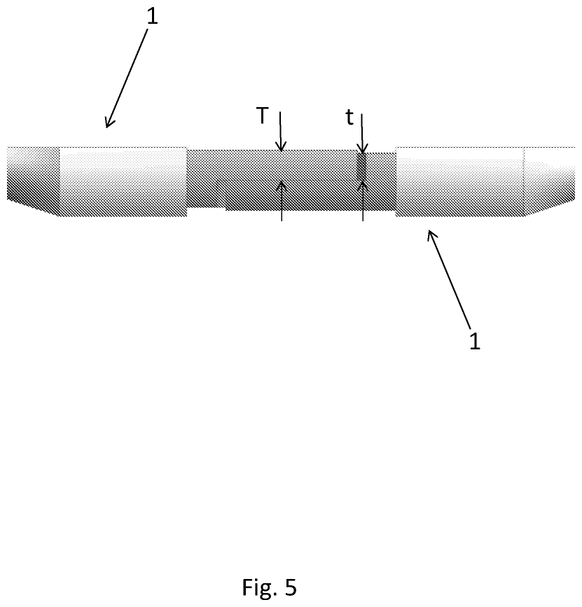

In the present arrangement, the first portion 6 comprises the connection face 5. Preferably, as is shown, the connection face 5 is recessed with respect to the second portion 5. A step may be defined between the first and second portions, as best seen in FIG. 5. The recess may be shallower than a thickness of the first portion 6. This is shown in FIG. 5, wherein the thickness T of the first portion 6 is greater than the depth of the recess t. This is beneficial in respect of the application of a preferable clamping force using a screw of similar, as discussed further below.

An opening 8 is preferably provided that passes through the connection face. The opening preferably extends though the body portion 2.

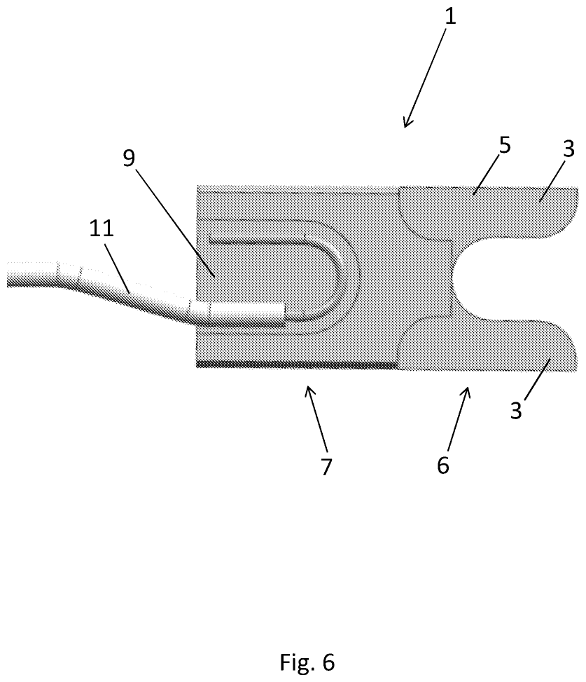

A recess 9, as shown in FIG. 6, is preferably provided for receiving a wire 11 to be joined to the connector 1. The form of the recess 9 is not particularly limited. It may be straight or curved in profile, or a combination, as shown. It could comprise a groove or channel. It is preferable that the wire is attached to the connector body 2 by welding. Most preferably by spot welding. The use of welding is beneficial since it avoids the need for a filler material. The connector may be provided with a sleeve 12. In such case, the sleeve 12 will be useful to reinforce/secure the connection of the wire to the connector body 2. The sleeve preferably covers the recess 12 for receiving the wire, as shown in FIGS. 1 and 2. The sleeve may comprise a heat activated material, which shrinks upon the application of heat, as is well known in the art.

The connector body 2 is most preferably unitarily formed. It may be formed by machining a solid blank of metal. It is preferable that the connector body 2 and the wire 11 are the same metal.

Returning to the male and female parts 3, 4, in the present arrangement, as best seen in FIG. 1, these may be considered to lie in different planes to one another. The planes may be parallel to one another, as shown.

The male members 3 of the present arrangement comprise prongs. The opening 8 is formed between adjacent prongs. The female parts 4 comprise cutouts formed in the step defined by the recess, such that the step has a profile conforming at least in part to the profile of the male parts 3.

The prongs comprise tips with curved inner faces and the cutouts have a corresponding curved profile. The tips and cutouts may be otherwise profiled in alternative arrangements. A base portion of the opening between the prongs is preferably curved, and is most preferably semi-circular. With a semi-circular base portion, when the connector 1 is connected to an identical connector 1 to form a connection, as shown in FIG. 2 and discussed below, the base portions of the two connectors (arranged at 180 degrees to one another) combine to define an opening through the connection that has a circular profile, as may be seen in FIG. 2. In alternative arrangements this need not be the case.

As will be appreciated, the form of the prongs (or more generally the male part(s)) and the cutouts (or more generally the female part(s)) in not particularly restricted. Various alternative forms to those shown will be readily appreciated by those skilled in the art.

As discussed, with reference to FIGS. 2 and 5, there is shown an assembly (or connection) comprising a pair of the connectors 1 according to the present arrangement. The connectors are, as is preferable, connected to one another with the male and female parts 3, 4 interconnected when the connectors 1 are oriented at 180 degrees to one another. The connection faces 5 contact one another. The openings 8 of the connectors are aligned with one another, whereby a clamping fastener may pass through the connection for clamping the connectors 1 together and the connection faces 5 against one another.

With reference now to FIGS. 3 and 4, the connector 10 of the second embodiment will be considered. Like features are labelled with like reference numerals to the connector 1 of the first embodiment. As will be readily appreciated, the connector 10 of the present arrangement differs from the connector 1 of the first embodiment principally in respect of the form/configuration of the provided male and female parts 3, 4. The connector body 2 is again preferably unitarily formed.

It must be noted, for example, that features discussed with respect to FIGS. 5 and 6 may be incorporated into the connector 10 of the present arrangement. For example, the portion of the connector body 2 of the depicted connector 10 covered by the sleeve 12 may be identical to that of the connector 1. It must further be noted that any modifications or alternatives discussed with respect to the first embodiment may be applied in respect of the present arrangement.

The discussion will accordingly focus on the arrangement of the male and female parts 3, 4.

In contrast to the connector 1, the male and female parts 3, 4 of the connector 10 extend along axes that are substantially perpendicular to the connection face. They may still be considered to lie in different planes to one another with the planes parallel to one another. Of course, as with the connector 1, with modifications to the male and female parts 3, 4 this need not be the case.

The male part 3 projects from the connection face 5. The male part 3 may be considered to comprise a lug. The female part 4 is formed in the connection face. In the present case, as is preferable, the female part is defined by the opening 8. It may alternatively be separately formed.

The male part 3 may be provided on a periphery of the opening with a profile conforming in part to the profile of the opening. It preferably has an inner face lying on and conforming to the profile of the end portion of the opening 8, as shown. It may, in accordance with the present arrangement, further have with an outer face that is semi-circular and conforms to the profile of the end portions of the opening 8. The male part 3 may, as shown, be substantially crescent shaped.

The opening 8 may have an elongate profile, as shown. It may be substantially oval. It preferably has curved end portions. The end portions are most preferably semi-circular. The opening 8 may have straight sides extending between the curved end portions, as shown. It may, however, take alternative forms.

With semi-circular end portions for the opening and inner and outer semi-circular faces for the male part 3, when the connector 10 is connected to an identical connector 10 to form a connection, as shown in FIG. 4, the male parts 3 received within the openings 8 with the two connectors (arranged at 180 degrees to one another) combine to define an opening through the connection that has a circular profile, as may be seen in FIG. 4. In alternative arrangements this need not be the case.

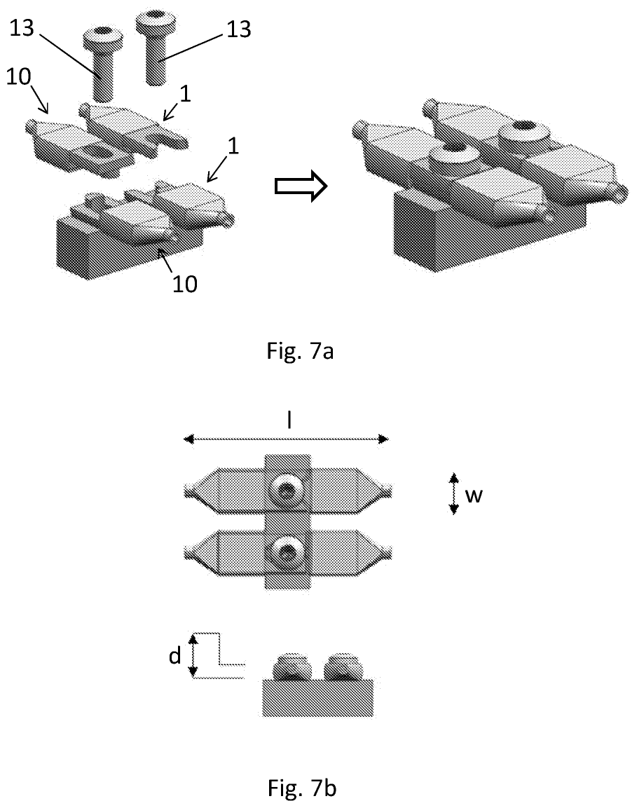

With reference to FIGS. 7a and 7b, there is shown a set of connectors comprising: a first pair of connectors comprising first and second connectors 1 according to the first embodiment, and a second pair of connectors comprising third and fourth connectors 10 according to the second embodiment. Like connectors are joined to one another as shown. The connectors are clamped against one another using screws 13, which are received through the aligned openings 8 in the connectors.

A benefit of the connectors according to the present invention is that the connections formed by two of the connectors connected to one another are smaller than is generally feasible with prior art thermocouple connectors. The connectors according to the first and second embodiments have overall dimensions, including the connector bodies 2 and sleeves 12, of: length l=24 mm, width w=4.6 mm, and depth d=2.4 mm. The screws 13 are M2 screws, having a diameter of 2 mm. As will be appreciated, embodiments are not limited to these specific dimensions. The dimensions may, for example, be any values within the following limits: length l=30 mm or less, width w=10 mm or less, and depth d=5 mm or less, or length l=25 mm or less, width w=5 mm or less, and depth d=2.5 mm or less. In yet further, less preferred alternatives, the dimensions may be greater than those specified above, particularly in the event the connectors are arranged for use as other than thermocouple connectors.

Therefore, the disclosed connectors are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Although various example embodiments have been disclosed, a worker of ordinary skill in this art would recognize that certain modifications would come within the scope of this disclosure. For that reason, the following claims should be studied to determine the scope and content of this disclosure.

1. A connector comprising a connector body configured for connection to an identical connector body, the connector body having a male part and a female part, which have profiles that conform, at least partially, to one another.

2. A connector as claimed in claim 1 comprising a substantially planar connection face.

3. A connector as claimed in claim 2, wherein the connector body comprises a first portion and a second portion, wherein the first portion comprises the connection face and is recessed with respect to the second portion.

4. A connector as claimed in claim 3, wherein a step is defined between the first and second portions.

5. A connector as claimed in claim 2, wherein the connector comprises an opening passing through the connection face.

6. A connector as claimed in claim 1, wherein connector comprises a recess for receiving a wire to be joined to the connector.

7. A connector as claimed in claim 6 further comprising a sleeve that covers the recess for receiving the wire.

8. A connector as claimed in claim 1, wherein the connector body is unitarily formed.

9. A connector as claimed in claim 1, wherein the male and female parts lie in different planes to one another.

10. A connector as claimed in claim 1, wherein the male and female parts extend along axes that are parallel to one another.

11. A connector as claimed in claim 1, comprising a plurality of the male parts that comprise prongs.

12. A connector as claimed in claim 11, wherein the connector comprises a substantially planar connection face and an opening passing through the connection face and formed between adjacent prongs.

13. A connector as claimed in claim 4, wherein the female part comprises a cutout formed in the step, such that the step has a profile conforming at least in part to the profile of the male part.

14. A connector as claimed in claim 2, wherein the male and female parts extend along axes that are substantially perpendicular to the connection face.

15. A connector as claimed in claim 14, wherein the male part projects from the connection face.

16. A connector as claimed in claim 14, wherein the connector comprises an opening passing through the connection face and the male part is provided on a periphery of the opening with a profile conforming in part to the profile of the opening.

17. A connector as claimed in claim 16, wherein the opening has an elongate profile.

18. A connector as claimed in claim 16, which comprises a thermocouple connector.

19. (canceled)

20. An assembly comprising a pair of the connectors as claimed in claim 19, wherein the connectors are arranged to be connected to one another with the male and female parts interconnected when the connectors are oriented at 180 degrees to one another.

21. (canceled)

22. (canceled)

23. A set of connectors comprising:
a first pair of connectors comprising first and second connectors according to claim 1, which comprise identical connector bodies to one another; and
a second pair of connectors comprising third and fourth connectors according to claim 1, which comprise identical connector bodies to one another, wherein the connector bodies of the first and second connectors are different to the connector bodies of the third and fourth connectors.

24. (canceled)

25. (canceled)
